(19) United States
(12) Patent Application Publication
(10) Pub. No.: US 2009/0307505 A1
(43) Pub. Date: Dec. 10, 2009

(54) Sensing Socket Assembly

(76) Inventors: Peter S. Robertson, Nottingham (GB); Ian R. Browne, Nottingham (GB)

Correspondence Address: RYAN KROMHOLZ & MANION, S.C., POST OFFICE BOX 26618, MILWAUKEE, WI, 53226, US

(21) Appl. No.: 11/922,730

(22) PCT Filed: Jun. 21, 2006
(86) PCT No.: PCT/GB2006/002274

§ 371 Date: Nov. 17, 2008

(30) Foreign Application Priority Data
Jun. 21, 2005 (GB) 0512617.2

(51) Int. Cl. G06F 1/26; H02J 3/14

(52) U.S. Cl. 713/300; 307/39

(57) ABSTRACT

A power distribution apparatus to control the supply of electrical power to a suite of master and peripheral devices, the apparatus comprising a master electrical outlet and at least one slave electrical outlet, both connectable to a common power supply. The apparatus including a sampling means adapted to sample power drawn from the master electrical outlet, and a controller adapted to calculate an updating average of a plurality of sampled power levels and operable to isolate the slave electrical outlet from the power supply in response to a prescribed change in the calculated average power drawn from the master electrical outlet relative to an automatically calculated switching threshold.

The present invention relates to socket assemblies and their use in the supply of electrical power to suites of master and peripheral devices.

There are a number of electronic “master” devices (e.g. computers, audio-visual and audio equipment) that are capable of being connected to, and used in conjunction with, one or more “peripheral” devices such as printers, scanners and monitors or hi-fi separates. Although each peripheral device is only ever used in conjunction with the master device, it is often the case that each peripheral device requires its own connection to a power supply.

Although “trailing lead” socket bank assemblies provide a solution to the problem of how to provide sufficient numbers of power supply outlets for suites of master and peripheral devices, they do not address a further problem arising from such suites. That is, because each peripheral device is often independently connected to an outlet of the socket bank, each such device may need to be turned off or isolated from the mains supply separately. Where a number of different peripheral devices are connected to a master device, the user of that master device may not remember and/or wish to expend the effort to turn off all of the peripheral devices at the same time as the master device. The upshot of this can be that peripheral devices are left in operation, or at least connected to the mains supply, during periods when the master device is not in use. The consumption of electrical power by the peripheral devices during such periods can cause unnecessary expense for the user. Moreover, wasting energy can ultimately have a negative effect on the environment, by requiring additional consumption of fossil fuels etc.

The problem of controlling power to a suite of master and peripheral devices has been addressed by the socket assemblies of co-pending application GB2386004 and granted patent GB2398441, both in the name of Peter Robertson. Using these assemblies, peripheral devices can be powered down (i.e. turned off) when a change in operating state of the master device is sensed, by monitoring the power drawn through a master electrical outlet of the socket assembly, thereby allowing the whole suite of devices to be turned off when the master device is turned off, or placed into a standby state.

Although these assemblies provide an automatic calibration of the threshold at which the switching of the peripheral devices is performed, there is a need in the art to provide an automatic calibration which is more robust and more responsive to changes in the power consumption characteristics of a master device connected to the assembly.

A common disadvantage presented by suites of master and peripheral devices is that, in the particular case of a computing suite for instance, the computer usually includes insufficient interface ports for the number of peripheral devices required to be connected. Hence, typically, multi-way adaptors, multi-port hubs and extension leads may all be commonly used to supplement the deficiency in interface ports, all of which may add further complexity to connecting the suite of devices. Moreover, a plurality of adaptors, hubs and leads also increases the amount of space occupied by the suite of devices, as well as adding to the number of trailing cables and hardware components required within the environment of the suite. This may be impractical, and costly, for the typical user and can be aesthetically unpleasing, particularly in a home or office environment. Furthermore, a prevalence of trailing cables can be dangerous, especially if routed across a floor, since the chances of accidental tripping of a user are increased significantly.

A further problem encountered by users of suites of master and peripheral devices, is that it is generally not possible to directly monitor the power consumption and power usage characteristics of the master and peripheral devices themselves. This problem can be particularly disadvantageous to users of certain devices (e.g. computers and computer peripherals), since it can be useful to monitor power consumption so as to (i) estimate the cost of power consumption, and (ii) to determine if one or more of the devices are beginning to exhibit anomalistic power variations due to a failing component. The ability to monitor power consumption could lead to cost savings and/or provide early warning of potential problems, so as to avoid future damage to a device, which may be costly to repair or else require a replacement device to be purchased.

In the present invention we describe an improved power distribution apparatus, having a robust switching threshold setting algorithm and offering multi-functional capabilities, which we have found solves some or all of the above-mentioned problems.

According to one aspect of the present invention there is provided a power distribution apparatus comprising:
a master electrical outlet and at least one slave electrical outlet, both connectable to a common power supply;
a sampling means adapted to sample power drawn from the master electrical outlet; and
a controller adapted to calculate an updating average of a plurality of sampled power levels and operable to isolate the slave electrical outlet from the power supply in response to a prescribed change in the calculated average power drawn from the master electrical outlet relative to a switching threshold.

According to another aspect of the present invention there is provided a method of power distribution comprising the steps of:
supplying electrical power to a master electrical outlet and at least one slave electrical outlet via a common power supply;
sampling power drawn from the master electrical outlet via a sampling means;
calculating, by way of a controller, an updating average of a plurality of sampled power levels; and
isolating the slave electrical outlet from the power supply in response to a prescribed change in the calculated average power drawn from the master electrical outlet relative to a switching threshold.

Embodiments of the present invention will now be described by way of example and with reference to the accompanying drawings in which:

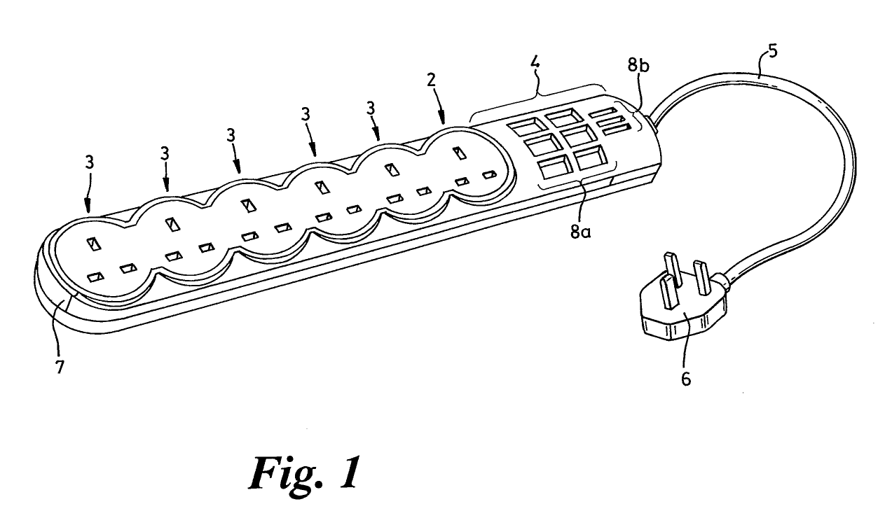

FIG. 1 is a schematic representation of the power distribution apparatus of the present invention.

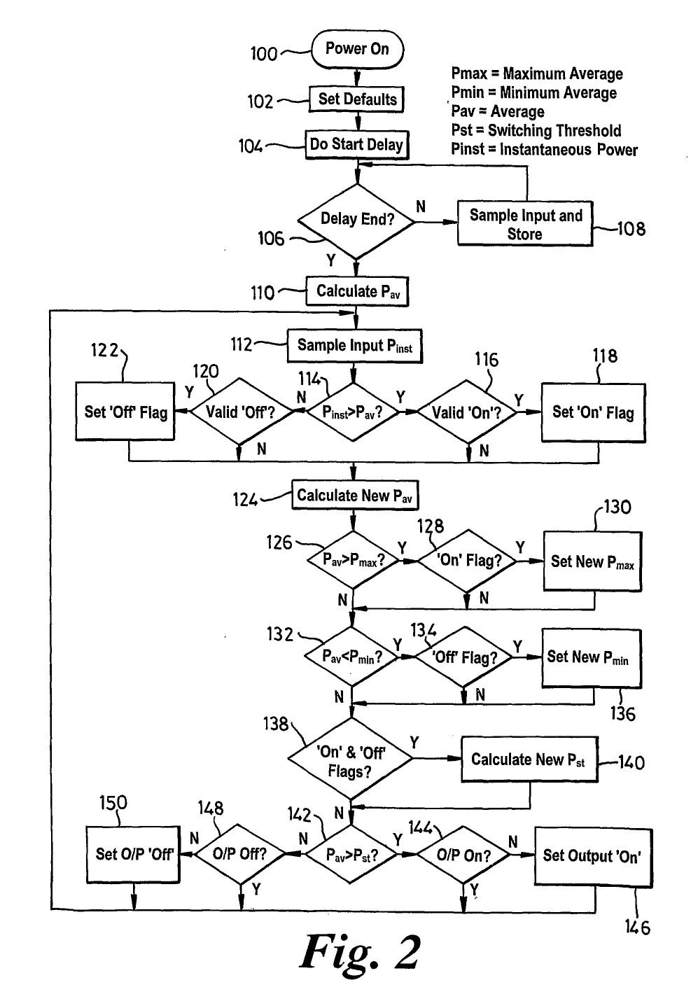

FIG. 2 is a flowchart of a switching algorithm according to the present invention.

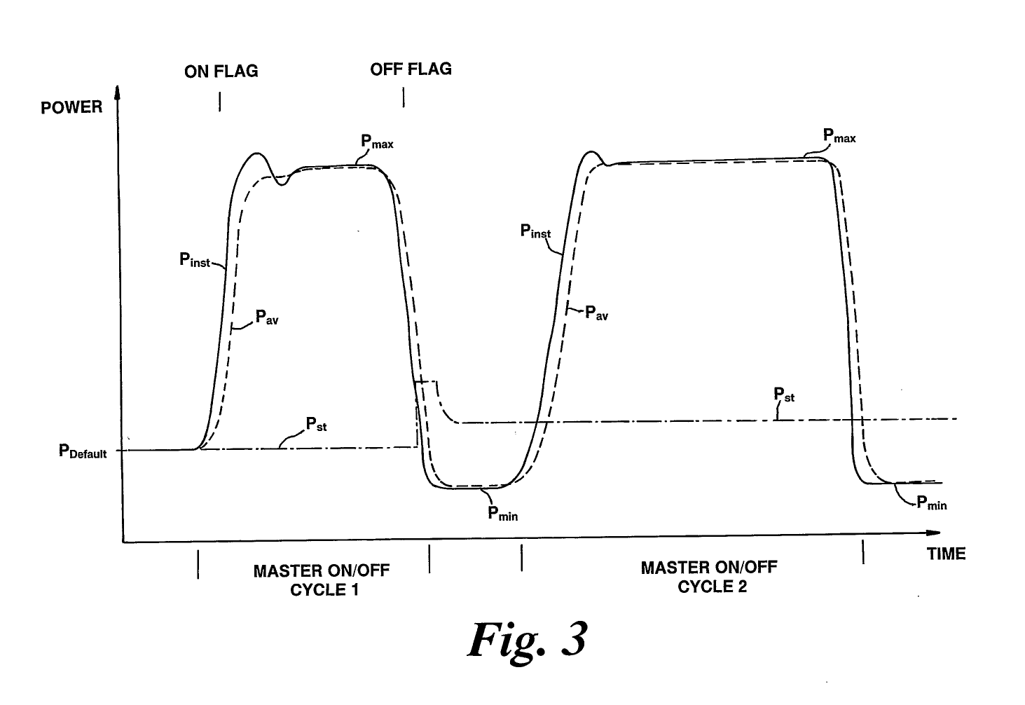

FIG. 3 is a graphical illustration of example power levels associated with a master device undergoing two typical power switching operations (master on/off cycles), according to a power distribution apparatus having a switching algorithm as shown in the flowchart of FIG. 2.

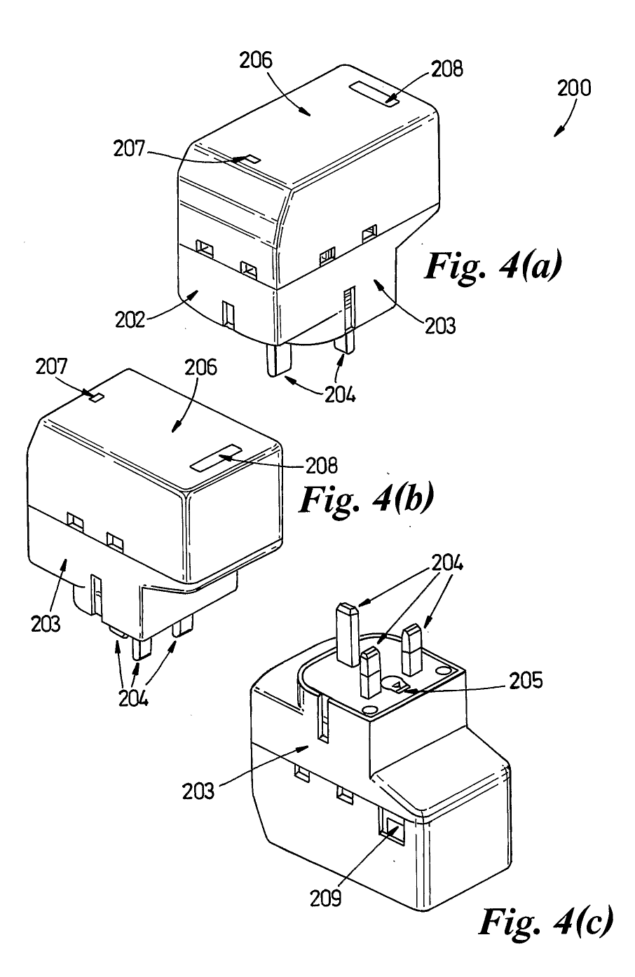

FIGS. 4(a)-(c) are perspective views of an alternative arrangement of the power distribution apparatus of the present invention.

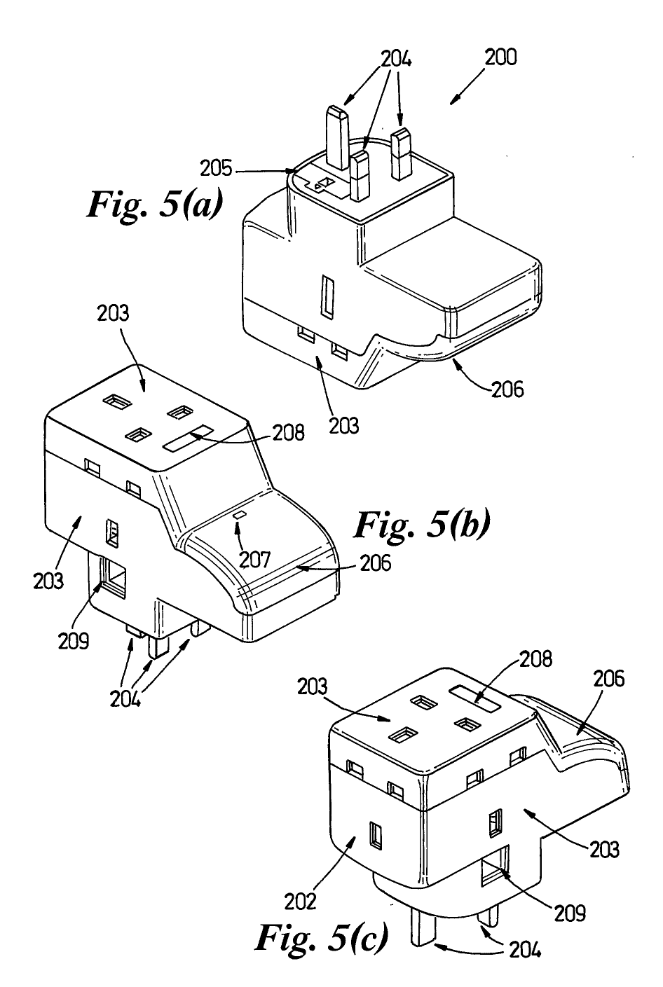

FIGS. 5(a)-(c) are perspective views of another alternative arrangement of the power distribution apparatus.

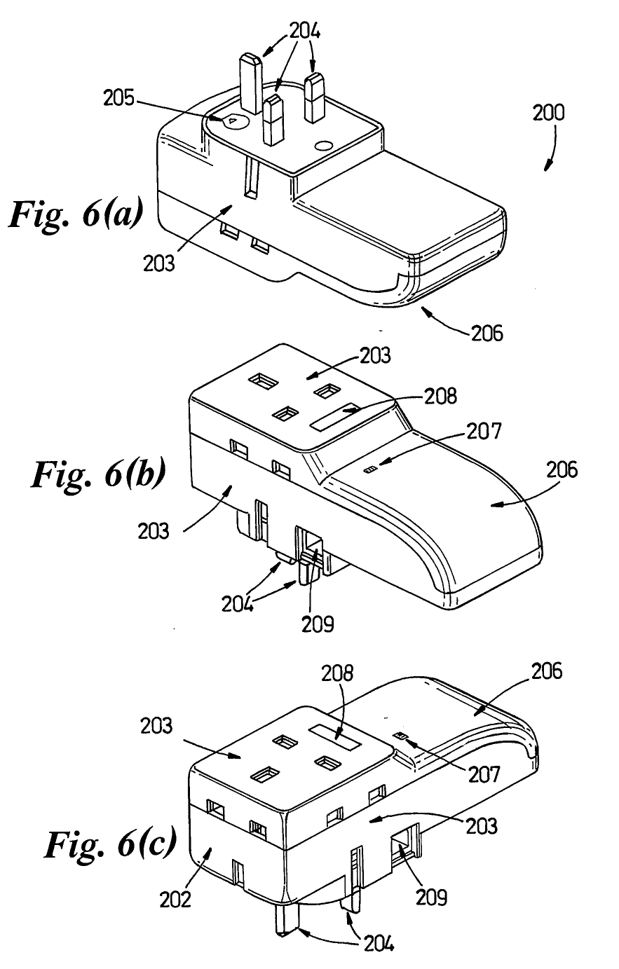

FIGS. 6(a)-(c) are perspective views of another alternative arrangement of the power distribution apparatus.

With reference to FIG. 1 there is shown a power distribution apparatus according to a particularly preferred arrangement of the present invention, comprising a socket bank 1, including at least one master electrical outlet 2 and one or more slave electrical outlets 3. An internal controller is located inside the region designated by 4 and a lead 5 provides an electrical connection between the controller and a plug 6, which is of a type suitable for use with electrical mains sockets.

It is to be appreciated that the socket bank 1 may be adapted to supply electrical power derived from any suitable power supply to the master electrical outlet 2 and the at least one slave electrical outlet 3. Suitable power supplies may include a battery, a generator or, most preferably, the mains.

In preferred arrangements, a master device (e.g. personal computer, television etc.) is inserted into the master electrical outlet 2 and electrical power for the device is drawn from that outlet. The master electrical outlet 2 is available to supply electrical power whenever the socket bank 1 receives electrical power.

The power dragon from the master electrical outlet 2 is sampled by a sampling means (not shown) in communication with the controller.

Electrical power may be supplied to the socket bank 1 by any suitable means, such as the plug 6, which is preferably connected to the apparatus via a lead 5 (e.g. a flexible lead of the type typically used with trailing-lead socket banks as shown). When electrical power is supplied to the apparatus in this way, each electrical outlet is supplied with electrical power by way of electrical connections from the lead 5.

In preferred arrangements, the controller is based on a microprocessor circuit that is capable of supplying or interrupting electrical power to the at least one slave electrical outlet 3, while providing continuous electrical power to the master electrical outlet 2. The microprocessor is preferably of a type that can be directly programmed (e.g. PIC) and operable to execute one or more switching algorithms. Alternatively, in other arrangements, the controller may be implemented using analogue circuitry.

A controller suitable for use with the present power distribution apparatus is described in granted patent GB2398441 in the name of Peter Robertson, modified in accordance with the prescribed improvements of the present invention.

The master device may be any electronic device that undergoes a change in operating state giving rise to corresponding changes in power consumption, which are detectable by the controller. As such. master devices include those that are capable of producing, or being adapted to produce, a change in the level of power consumption as a consequence of, for example, turning “on”, turning “off”, and entering or exiting a standby state.

Herein, when the master device is “off” it is assumed that the device is no longer drawing power from the master electrical outlet 2, or else is drawing power at a negligibly low level. Whereas, when the master device is in a “standby” state, the device is consuming power at a reduced level, and is essentially in a sleeping state, awaiting instructions from a user so as to awaken and perform a desired task (e.g. a television or computer when in a standbys state). An “on” state is taken to be when the master device is operating or functioning at a power level which is at, or close to, its maximum or normal power consumption, and is therefore significantly higher than both the “off” and “standby” state power levels.

Typically the power level of a standby state of a master device is of the order of several watts (W), but varies depending on the power consumption characteristics of the particular master device, and may be up to several tens of watts.

The master device will typically be associated with one or more peripheral devices, for example, as in a computing suite comprising a printer, scanner, modem and monitor etc. When used herein, the term “peripheral devices” is taken to include electronic devices that operate in conjunction with the master device (e.g. by sending to and/or receiving from the master device a signal and/or data) in order to perform a function. It is to be appreciated however, that some peripheral devices may also be associated with a master device, but need not be in communication with the master device. for example, such as a desk lamp or paper shredder forming part of a computing suite. In this case, it would be desirable to turn these devices off when the computing suite is no longer in use.

The operating states of the master device ideally correspond to distinct power consumption levels. The levels are therefore characteristic of the power requirements of that particular master device. Any change in the operating state of the master device produces a corresponding change in the level of power consumption.

In preferred arrangements, the sampling means is adapted to periodically sample the power drawn from the master electrical outlet 2 by a connected master device. The sampling means operates in much the same manner as the sensing means described in the aforementioned granted GB patent, but modified in accordance with the present invention, and preferably measures the resulting voltage developed across a load (of known resistance) by the current drawn through the master electrical outlet 2 by the master device.

It is to be appreciated that, any suitable method of sampling the power drawn from the master electrical outlet 2 may be used, in accordance with the apparatus of the present invention, including, but not limited to, inductive and thermal techniques.

The sampling means preferably samples the instantaneous power drawn from the master electrical outlet 2 at sampling intervals of between about 0.1 seconds to about 1 second, and most preferably at a sampling interval of about 0.5 seconds. In this way, it is possible to track the changes in the power consumption of the master device substantially in real-time. It is to be appreciated however, that the sampling interval may be set at any suitable time interval, depending on the particular application and desired mode of power monitoring.

In preferred arrangements, the controller is adapted to receive the plurality of sampled power levels from the sampling means and to calculate an updating average value of the sampled power levels. In this way, a robust indicator of the level of power consumption of the master device can be calculated during operation of the particular suite of devices. The updating average is preferably calculated as a rolling average of the 8 most recently sampled power levels, as sampled by the sampling means.

However, it is to be appreciated that any number of sampled power levels may be used in the calculation of the rolling average, provided that the number is greater than or equal to 2, and that the period over which the samples are obtained is not sufficiently long in duration so as to mask changes in the average from being detected.

In accordance with the present invention, the controller monitors the value of the updating average so as to decide whether a change in the operating state of the master device has occurred, such as turning on or turning off etc. If the controller decides that the master device has undergone a change in operating state, it will act to either isolate, or connect (if not already connected), the at least one slave electrical outlet from, or to, the common power supply. As a result, any peripheral devices connected to one or more of the slave electrical outlets 3, will be powered up or powered down in accordance with the change in operating state of the master device. In this way, if, for example, the master device is turned off, then each of the peripheral devices will be correspondingly automatically turned off.

In preferred arrangements, the operation of the present apparatus is controlled by at least one pre-programmed algorithm, which is executed by the controller when power is supplied to the socket bank 1. Preferably, the algorithm is loaded (or programmed) into a non-volatile storage device (e.g. a ROM chip) within the controller during fabrication of the power distribution apparatus.

Referring to FIG. 2, there is a shown a flowchart of a particularly preferred switching algorithm according to the present invention. The flowchart illustrates the preferred steps in the switching algorithm, starting from when the power distribution apparatus is first connected to the mains (i.e. “Power On”—step 100). The preferred steps 102 to 110 correspond to the ‘initialisation phase’ of the apparatus which occurs every time power is first supplied to the apparatus. The preferred steps 112 to 150 correspond to the ‘operating phase’ of the apparatus, which follows the initialisation phase, and controls the operation of the apparatus during normal use with a suite of master and peripheral devices.

In accordance with preferred arrangements, the controller in executing the algorithm of FIG. 2, sets a number of initial power values (described below) to a default nominal value, P_{Default} (as represented by step 102), when power is first supplied to the apparatus (step 100). Preferably the default nominal value P_{Default} is in the range of about 1 W to about 30 W, and is most preferably about 25 W. However, it is to be appreciated. that any, relatively small, positive value may be used.

The controller then waits for a pre-set interval of time (steps 104-106), following the instant at which the power is first supplied, to allow high inrush currents and initial power spikes to dissipate in the apparatus. Preferably, the pre-set interval of time is approximately in the range of about 1 to about 10 seconds, but is most preferably about 5 seconds.

In preferred arrangements, during the pre-set interval of time, the sampling means periodically samples the instantaneous power drawn, Pᵢₙₛₜ, from the master electrical outlet 2, to provide a plurality of sampled power levels (step 108). Each sampled power level provides a measurement of the instantaneous power Pᵢₙₛₜ being consumed by a master device connected to the outlet 2 at the time of the measurement. These sampled power levels are used to calculate the rolling average power, Pₐᵥ, consumed by the master device during the pre-set interval of time (step 110), the calculated average replacing the initial value of Pₐᵥ which is set to P_{Default}.

By way of example, the variations in the power levels involved with the operation of a typical master device are illustrated in FIG. 3, in which the master device can be seen to undergo two consecutive on/off cycles (herein referred to as “master on/off cycles”), corresponding to a transition from an off state to an on state, and then to a standby state (master on/off cycle 1), which is then repeated over a slightly longer duration (master on/off cycle 2).

Following the initial calculation of the average power Pₐᵥ (step 110), the controller preferably enters the operating phase of the algorithm (steps 112 to 150), while the sampling means continues to sample the instantaneous power Pᵢₙₛₜ consumed by the master device from the master electrical outlet 2 (step 112). After each sample is obtained, the controller determines using conditional logic whether the sampled power level Pᵢₙₛₜ is greater than the currently calculated average power Pₐᵥ (step 114). If this is found to be true, the controller then invokes an edge detection routine (step 116) which attempts to identify the first rising edge of the master on/off cycle (see FIG. 3). Preferably, the controller decides that it has identified the first rising edge (i.e. a Valid ‘On’ condition—step 116) if the difference between the values of the sampled power Pᵢₙₛₜ and average power Pₐᵥ is greater than about 8 W, and that at least 3 contiguous samples (obtained by the sampling means) each indicate a consecutive rise in power drawn by the master device.

Should the controller decide that the master device has undergone a change of operating state following identification of the first rising edge, it will then preferably set an internal flag bit, preferably held in memory, to a state corresponding to ‘On’ (step 118).

Returning to step 114 of FIG. 2, if the instantaneous power level Pᵢₙₛₜ is less than the average power Pₐᵥ, the controller attempts to determine whether the master device has undergone a change in operating state corresponding to the master device entering a standby state or turning off, as illustrated by the latter portion of master on/off cycle 1 in FIG. 3. The controller once again invokes the edge detection routine, so as to identify whether the first falling edge of the master on/off cycle has been detected. In order to identify the first falling edge (i.e. corresponding to the Valid ‘Off’ condition—step 120), the controller preferably needs to determine whether the absolute difference in sampled power Pᵢₙₛₜ and average power Pₐᵥ, is greater than about 8 W, and if at least 3 contiguous samples (obtained by the sampling means) each indicate a consecutive fall in power drawn by the master device.

Should the controller decide that the master device has undergone a change of operating state following identification of the first falling edge, it will then preferably set an internal flag bit, preferably held in memory, to a state corresponding to ‘Off’ (step 122).

Hence, it is to be appreciated that the ‘On’ and ‘Off’ flag bits are only ever both true following the first complete master on/off cycle, as illustrated in FIG. 3.

It is to be noted that the absolute difference in power may be greater than or less than about 8 W, depending on the particular application, and that the number of contiguous samples may be any number equal to, or greater than 2, as required by the edge detection routine in determining whether a ‘Valid On’ or ‘Valid Off’ condition has been met.

Having sampled the instantaneous power Pᵢₙₛₜ (step 112), and compared it to the currently calculated value of the average power Pₐᵥ (step 114), the controller uses the value Pᵢₙₛₜ to update the value of the average power Pₐᵥ (step 124). In preferred arrangements, the algorithm performs the averaging operation on the plurality of sampled power levels and stores each newly calculated average value in an associated storage means, such as RAM within the controller.

An advantage of calculating a rolling average of the instantaneous power Pᵢₙₛₜ drawn from the master electrical outlet 2, is that any initial spikes in the instantaneous power, such as those encountered following the turning on of a master device, can be mathematically smoothed or substantially evened out (as illustrated by the curves Pᵢₙₛₜ, Pₐᵥ in master on/off cycles 1 and 2 of FIG. 3).

Once the inrush currents dissipate, typically after a few seconds, the instantaneous power Pᵢₙₛₜ settles at a substantially ‘stable’ power level (shown as plateau regions in FIG. 3), which corresponds to a maximum or normal power consumption level of the master device when the device is turned on.

In accordance with preferred arrangements, the controller sets an initial power value, during the initialisation phase (step 102), corresponding to the calculated average of the maximum power drawn Pₘₐₓ from the master electrical outlet 2 by the master device. The calculated average power Pₐᵥ is then compared (step 126) to this average maximum power Pₘₐₓ, after each update of the average power Pₐᵥ (step 124). If the controller determines that the average power Pₐᵥ is greater than the average maximum power Pₘₐₓ, it checks to see if the ‘On’ flag has been previously set (step 128), due to the first rising edge having been detected. Should the ‘On’ flag be true. the controller updates the value of the average maximum power Pₘₐₓ, by preferably setting it equal to the most recently updated value of the average power Pₐᵥ (step 130). In this way, the value of the average maximum power Pₘₐₓ may be continuously updated, in accordance with increasing values of the average power Pₐᵥ drawn from the master electrical outlet 2.

In the case when the ‘On’ flag is false, the algorithm does not update the average maximum power Pₘₐₓ, as the first rising edge has not yet been detected (and therefore the master device has yet to turn on), and instead passes control to the next step in the algorithm (step 132).

Whether or not the algorithm updates the value of the average maximum power Pₘₐₓ, the logical condition of the average power Pₐᵥ being less than an average minimum power level Pₘᵢₙ is tested (step 132). The average minimum power Pₘᵢₙ corresponds to the calculated average power drawn by the master device from the master electrical outlet 2 when the master device is in a standby state. This value is initially set (step 102) to a relatively high power value during the initialisation phase i.e. to exceed any likely value of Pₐᵥ. This ensures that the value of Pₐᵥ is below the value of Pₘᵢₙ (at step 132) in order for Pₘᵢₙ to be updated by the controller, so as to automatically calibrate the apparatus for use with the particular master device.

In accordance wit preferred arrangements, if the controller determines that the average power Pₐᵥ is greater than the average minimum power Pₘᵢₙ, control is passed to the next step of the algorithm (step 138). However, should the average power Pₐᵥ be found to be less than the average minimum power Pₘᵢₙ (as shown at the end of master on/off cycle 1 in FIG. 3) the controller checks to see if the ‘Off’ flag has been set (step 134). A true ‘Off’ flag causes the algorithm to update the value of the average minimum power Pₘᵢₙ, by setting it equal to the current value of the average power Pₐᵥ (step 136). In this way, the value of the average minimum power Pₘᵢₙ, may be continuously updated, in accordance with decreasing values of the average power Pₐᵥ drawn from the master electrical outlet 2.

As show in the example of FIG. 3, the average minimum power Pₘᵢₙ of the master device is lower than the value of P_{Default}, and therefore the instantaneous power Pᵢₙₛₜ and average power Pₐᵥ fall below the default level.

It is to be appreciated that in preferred arrangements, the algorithm proceeds to automatically calculate a switching threshold, Pₛₜ, provided that both the ‘On’ and ‘Off’ flag bits are true. Therefore, the present apparatus preferably only calculates a new switching threshold Pₛₜ following the first complete master on/off cycle, as both the ‘On’ and ‘Off’ flag bits are only set when the first rising and falling edges of the master on/off cycle are identified.

Only after one such cycle does the controller have sufficient information, relating to the characteristic power levels of the master device, to calculate an appropriate switching threshold for that device. In this way, the power distribution apparatus adapts itself for unique use with that particular master device, and retains knowledge of the power consumption characteristics of the device until such time power is interrupted to the apparatus.

The switching threshold Pₛₜ is one of the initial values that are preferably set (step 102) to the default nominal value P_{Default} during the initialisation phase (steps 100 to 110), and therefore the threshold remains at this value until the first master on/off cycle is completed (as shown in master on/off cycle 1 in FIG. 3). Use of an initial default switching threshold value is advantageous, as it insures that an incorrect threshold is not calculated, while the master device is gradually powering up, e.g. as in the case of a computer performing a boot-up sequence.

In accordance with particularly preferred arrangements, the algorithm calculates the switching threshold Pₛₜ based on the values of the average maximum power Pₘₐₓ and average minimum power Pₘᵢₙ. Preferably, the algorithm sets the value of the switching threshold Pₛₜ to a value which is the sum of the calculated average minimum power Pₘᵢₙ and a predetermined fraction f of the difference between the calculated average maximum power Pₘₐₓ and the calculated average minimum power Pₘᵢₙ. This can be expressed mathematically as:

Pₛₜ=Pₘᵢₙ+f[Pₘₐₓ−Pₘᵢₙ] Equ. 1

Preferably, the predetermined fraction f is in the range of about 0.15 to about 0.40, and is most preferably about 0.25. However, it is to be appreciated that the predetermined fraction may reside outside of this preferred range depending on the particular application.

By setting the switching threshold Pₛₜ to the value as provided by Equ. 1, the threshold is maintained at a level which is relatively higher than the standby power level of the master device, Pₘᵢₙ, but also significantly below the maximum or normal operating power level Pₘₐₓ.

As shown in the example of FIG. 3, the switching threshold Pₛₜ is seen to undergo a rapid increase in value once the ‘Off’ flag bit has been set (step 122), following the change in operating state of the master device at the end of the first master on/off cycle. This increase arises from the fact that at the time the ‘Off’ flag bit is set, the average minimum power Pₘᵢₙ still has the value of the default nominal value P_{Default}, which by virtue of Equ. 1, gives rise to a rapid increase in the value of the switching threshold Pₛₜ. Not until the calculated average power Pₐᵥ falls below the level of P_{Default}, does Pₘᵢₙ begin to fall, thereby causing the switching threshold Pₛₜ to decrease until it attains a ‘stable’ value, as given by the new value of Pₘᵢₙ in Equ. 1 (as shown during master on/off cycle 2 in FIG. 3).

According to the particularly preferred arrangements, after having set the switching threshold Pₛₜ, the algorithm tests the logical condition whether the average power Pₐᵥ is greater than the switching threshold Pₛₜ (step 142), and if this is found to be true, ascertains whether the slave outlets 3 are connected to the common power supply (step 144). If the slave outlets 3 are not connected, the controller acts to connect them (step 146), and thereby makes power available to the one or more peripheral devices attached to the slave outlets 3.

Therefore, any peripheral devices connected to the slave outlets will be switched into a corresponding operating state in response to the master device turning on.

If the slave outlets 3 are already connected to the common power supply, the controller bypasses this step, and continues to monitor the instantaneous power Pᵢₙₛₜ being drawn from the master electrical outlet 2 by the master device. In both cases, the algorithm returns to the step of sampling (step 112) the instantaneous power Pᵢₙₛₜ in preparation for updating the rolling average power Pₐᵥ at step 124.

In preferred arrangements, the controller will act to isolate (step 150) the slave outlets 3 if it determines that the average power Pₐᵥ has fallen below the value of the switching threshold Pₛₜ (step 142). If the slave outlets have already been isolated however, the algorithm will simply return to the step of sampling (step 112) the instantaneous power Pᵢₙₛ drawn by the master device from the master electrical outlet 2.

Thereafter, the controller continues to monitor the power consumption of the master device, while continuously comparing the most recently calculated average power Pₐᵥ against the currently stored values of the average maximum power Pₘₐₓ (step 126) and average minimum power Pₘᵢₙ (step 132), with the intention of dynamically adjusting the power switching threshold Pₛₜ, the average maximum power Pₘₐₓ and average minimum power Pₘᵢₙ, as required (steps 140, 130 and 136 respectively).

The process of dynamically setting the switching threshold Pₛₜ is advantageous, since the controller is able to adapt the switching threshold Pₛₜ to uniquely suit the power consumption characteristics of the connected master device, and to thereafter use this threshold as a reference power level in order to determine whether to isolate, or connect, the slave electrical outlets 3 when the particular master device undergoes a change in operating state. Therefore, as shown in the master on/off cycle 2 of FIG. 3, the master device undergoes another on/off switching cycle of slightly longer duration than the first master on/off cycle. During the second cycle the switching threshold Pₛₜ is set at the value given by Equ. 1. based on the average minimum power Pₘᵢₙ and the average maximum power Pₘₐₓ. Hence, when the master device undergoes a change in operating state, the calculated average power Pₐᵥ will correspondingly change, and the algorithm compares this average to the switching threshold Pₛₜ. If the average power Pₐᵥ increases above the switching threshold Pₛₜ, the slave electrical outlets 3 will be connected to the common power supply (step 146), however, should the average power Pₐᵥ fall below the switching threshold Pₛₜ the slave electrical outlets 3 are isolated from the supply (step 150).

In preferred arrangements, the controller stores the value of the switching threshold Pₛₜ in a suitable storage means, such as RAM within the microprocessor circuit. The switching threshold Pₛₜ is retained in memory until power is interrupted to the power distribution apparatus, whereupon the flag, bits are re-set and Pₛₜ is re-set to the default power level P_{Default} during the initialisation phase (steps 100 to 110).

Should a different master device be connected to the power distribution apparatus, the values of the average minimum power Pₘᵢₙ and average maximum power Pₘₐₓ will then be re-calculated during the subsequent master on/off cycle (whereupon both flag bits are set to true), thereby enabling the switching threshold Pₛₜ for that device to be determined by Equ. 1. In this way, the power distribution apparatus of the present invention, automatically calibrates itself to the particular power consumption characteristics of the connected master device.

In preferred arrangements, the at least one slave electrical outlet 3 is connected to the common power supply by forming an electrical connection between the slave electrical outlet 3 and the live power rail. Preferably, the controller controls a suitable electrical switching device adapted for use in forming the electrical connection between the slave outlet and the live power rail.

The electrical switching device may be any suitable device that is capable of making or breaking an electrical connection via either physical means or an electrically controlled conducting medium. As such, preferred devices include a bi-directional gate controlled thyristor (i.e. a triac) and a relay of the solid state or, preferably, the electromechanical variety.

Arrangements for forming an electrical connection between the slave electrical outlets 3 and the power supply are described in granted patent GB2398441 and any of these known arrangements may be used in the power distribution apparatus of the present invention.

The power distribution apparatus is preferably provided with surge protection (i.e. protection against damage by transient high voltages arising from the electrical power supply). This may be achieved by using techniques and methods known to those skilled in the art.

The power distribution apparatus may also be provided with a visual notification means operable to indicate supply of electrical power to the master electrical outlet 2 and/or the at least one slave electrical outlet 3

In other particularly preferred arrangements, in addition to monitoring the power consumption of the master device from the master electrical outlet 2, the power distribution apparatus may also monitor an electrical output derived from the master device. The information derived may then be used by the controller, possibly in conjunction with the calculated average power Pₐᵥ, to decide whether the master device has undergone a change in operating state, so as to either isolate or connect the slave electrical outlets 3 of the socket bank 1 to the common power supply.

Preferably, the sampling means is adapted to monitor changes in an electrical signal which is derived from an output of the master device, the changes in the signal corresponding to changes in the operating state of the master device. The changes are preferably changes in the power level of the signal, such that, for instance, when the master device turns off, the signal undergoes a change in power from a higher level to a relatively lower level.

For example, in a home computing suite, the master device will typically be the personal computer itself which provides a number of standard interfaces and bus connectors from which a signal indicative. of the current operating state of the computer may be derived. The electrical signal may therefore be an output voltage which is taken from one or more of the serial port, parallel port, Firewire port, ISA bus, PCI bus and universal serial bus (USB), with the sampling means being directly connected to the interface/bus by a hard wire connection.

Alternatively, the electrical signal may be in the form of an electromagnetic wave corresponding to one of the standard wireless protocols, such as WiFi and Bluetooth. In this arrangement, the sampling means could include a receiver which monitors wireless signals from the master device, so as to determine the current operating state of that device. By way of example, the master device could be a laptop or other portable computing device, having a USB dongle for wireless networking, and in which the sampling means monitors the signals from the dongle to determine whether the laptop has undergone a change in operating state. The sampling means may connect to the personal computer by way of an interface integral to the socket bank 1. Referring to FIG. 1, there is shown in the region generally denoted by 4, an interface of the bank 1, which may include a plurality of standard interface ports and connectors 8a, 8b.

It is to be appreciated that the interface is compatible with each of the preferred embodiments, and that the illustration in FIG. 4 is not intended to be limiting. Hence, the plurality of standard interface ports and connectors 8a, 8b may reside on any part of the external surface of the socket bank 1, in any suitable configuration.

The interface ports and connectors 8a, 8b may form part of the controller circuitry, or else can be fabricated as a separate module which is coupled to the controller.

In preferred arrangements, the interface is a standard USB hub, including a plurality of standard USB interface ports 8a, each suitable for connection to a USB peripheral device. Preferably the ports 8a are accessible via at least one face of the outer casing of the socket bank 1. The socket bank, 1 preferably includes a USB cable, which is either permanently, or removably, connected to a port in the interface. The cable is adapted to be connected to a USB port on the computer, thereby connecting the computer to the USB hub.

In preferred arrangements, the sampling means may use a USB cable to connect to a USB port on the computer, to monitor the output voltage of the USB port.

The inclusion of a USB hub is advantageous, since in the case of a suite consisting of a computer and peripherals, an integrated hub is able to solve the problem of insufficient interface ports, which is a common disadvantage in suites of computing and peripheral devices.

In other arrangements, the interface may include one or more standard telephone jack connectors 8b, preferably arranged as a multi-way telephone socket adaptor, each connector suitable for connection to a telecommunications device, such as, but not limited to, a telephone, modem or fax machine.

It is to be appreciated that arrangements including a USB hub and those including a multi-way telephone adaptor are not exclusive, and that arrangements in which the socket bank 1 includes both a hub and an adaptor are also preferred, and are in accordance with the present invention.

The USB hub may also comprise a switching device, preferably an electromechanical relay circuit, which is capable of isolating the peripheral devices which are connected to the ports of the USB hub from the hub power supply (which is provided by the USB port on the computer), in response to the controller determining that the master device has turned off or else has entered a standby state. This arrangement can be particularly advantageous for computers in which the USB ports remain ‘high’ (i.e. the output voltage stays on) after the computer has shut down, since the hub will remain powered but the peripherals can still be correspondingly turned off.

The USB hub switching device may also be responsive to ‘data traffic’ passing through the hub, such that, for example, if the hub detects data traffic from a USB mouse (i.e. digitally encoded signals corresponding to translation motion etc.) connected to the hub, the switching device may act to connect the ports of the USB hub to the hub power supply. This action would preferably be coordinated with the operation of the controller, which would have ultimate authority in determining any switching operation, relating to the slave electrical outlets 3, the USB hub or a combination of outlets and hub.

In accordance with other preferred arrangements, one or more of the slave electrical outlets 3 could be adapted so as to be independently addressable, such that the controller could be programmed via the interface from a computer executing a suitable control application. In this way, the switching of peripherals could be uniquely tailored to the particular suite of devices. For example, in a computing suite, it may be desirable for the slave electrical outlet to which a fax modem or network router is connected to remain powered when the computer is turned off. Hence, the user can instruct the controller not to isolate this particular slave outlet when the computer undergoes a change in operating state.

The user may therefore configure the socket bank 1 to his/her own particular requirements, depending on the desired application and/or types of master and peripheral devices. The controller may be adapted to retain the programmed instructions in a non-volatile memory, so that the designated slave outlets operate in the desired way even following an interruption of power to the socket bank 1.

It is to be appreciated that any suitable control application may be executed on the computer in order to program the controller via the interface. Preferably, the application includes a graphical user interface which allows one or more slave outlets 3 to be designated as switchable or non-switchable etc. depending on the desired requirements, which is then communicated to the controller preferably via a USB connection.

Alternatively, the controller may be programmed via a command line application using a suitable keyword protocol, which is interpreted by the controller so as to configure the one or more slave electrical outlets 3.

In other arrangements, there may be two or more master electrical outlets, so as to receive further master devices. Increasingly in computing suites of devices for instance, there may be two or more computers linked by a KVM (keyboard, video, mouse) switch, that share the same peripheral devices. Therefore, it is necessary to configure the socket bank 1, such that the peripheral devices are turned on when either of the master devices are active. Hence, the controller can be programmed in the manner of the foregoing arrangements, to connect the slave electrical outlets 3 to the power supply when either of the master devices undergo a change of operating state.

Each of the master electrical outlets could operate as described in the foregoing arrangements, however the slave electrical outlets 3 would only be isolated from the common power supply when both master devices turn off or else enter a standby state. either simultaneously or successively.

In particularly preferred arrangements, the controller is also adapted to provide a serial data stream comprising one or more power consumption statistics, based on the power drawn from each master electrical outlet 2 and/or each slave electrical outlet 3. This data stream may then be provided to a computer via the interface, where an event logger application interprets the statistics and provides analysis and/or graphical output illustrating the power consumption from the socket bank 1 over a desired timescale.

The event logger may be any computer executable application suitable for interpreting the data stream and presenting statistical analysis to a user on a display device on the computer.

Preferably, the event logger compiles a batch of historical power consumption data, which is then stored on a non-volatile storage device of the computer, e.g. a hard drive. The event logger is preferably in communication with the controller via a USB interface, which connects the USB port of the computer to the socket bank 1. The USB interface may be a dedicated interface solely for use by the event logger, or alternatively, may be part of the USB hub.

Alternatively, the interface may be RS232 port or serial port, suitable for connection to a RS232 port or serial port, respectively, on the computer.

By monitoring the power consumed by the master device and/or any peripheral devices connected to the socket bank 1, it is possible to determine the power usage characteristics of the individual devices, which can be advantageous in estimating the overall cost of operating the suite of devices, and may also be helpful in identifying any current problems with the devices.

The event logger may preferably receive the one or more power consumption statistics in real-time, for direct viewing, or alternatively, periodically as a batch of historical data, to be viewed retrospectively.

Although the socket bank 1 is ideal for managing the provision of power to a suite of devices, comprising one or more master devices and a plurality of peripheral devices, the controller may preferably be further adapted so as to communicate with other socket banks of the present invention via mains signalling. In this way, a network of socket banks 1 can be created within a home or office environment.

The controller can be modified to include a transceiving circuit, which is able to send a pulsed signal via the mains electrical (ring) circuit to instruct other socket banks to power down their respective master and/or peripheral devices. For example, a user working on a computer in a first floor study, could configure a network of socket banks 1 around his/her home, such that when the computer is turned off at the end of the day, all the other devices throughout the home (which are connected to respective socket banks) are also turned off. Therefore, the user need not physically enter the rooms of the home to turn off his/her devices.

Preferably, the socket banks are individually configurable, so that only those socket banks having devices which are desired to be turned off, would respond to the pulsed signal. Hence, the respective controllers could be programmed to respond to pulsed signals or else to ignore them, depending on their location within the home or office etc.

In alternative arrangements, the socket banks 1 could be adapted to communicate via wireless protocols, such as, but not limited to, WiFi and Bluetooth.

A further modification which is consistent with each of the foregoing preferred arrangements, is to configure the power distribution apparatus to be controlled by a remote control device, preferably, an infra-red remote control hand unit. The socket bank 1 could be adapted to include a remote control switching unit, preferably forming part of the controller circuitry, which would act to isolate all of the outlets (both master and slave) from the common power supply, in response to receiving a predetermined instruction (i.e. a remote control signal) from a user. In this way, the user can isolate all the devices from the mains supply, for instance, when the devices within the suite are off. Advantageously, the possibility of electrical fire and/or accidental electrocution may be significantly reduced, as the master devices are no longer left connected to the mains after they have been turned off.

In preferred arrangements, the controller may be configured to remain dormant (or idle) following the connection of the socket bank 1 to the mains supply, until the controller receives a ‘wake-up’ signal from the remote control switching unit. This signal may arise from either the unit receiving a remote control signal from a user, or from detecting that an ‘override switch’ coupled to the unit has been operated. Thereafter, the controller wakes up and acts to make power available to the master electrical outlet 2, whereupon the subsequent operation of the socket bank 1 is in accordance with the previously described arrangements.

Preferably, the override switch is any suitable electrical switch device, such as, but not limited to, a push-button switch, a touch-sensitive pad, and a photo-sensitive cell etc., which is mounted on an external surface of the socket bank 1.

In accordance with preferred arrangements, the socket bank 1 is fitted with a infra-red detector or sensor, coupled to the remote control switching unit, and mounted on an external surface of the socket bank 1. The sensor may be any suitable conventional infra-red sensor that is capable of receiving infra-red signals over a suitable range of operating distance, e.g. up to several metres from the socket banc 1.

In alternative arrangements, the sensor may be an optical sensor, configured for use in the visible part of the electromagnetic spectrum, which is operable to respond to visible light. e.g. flashes of light from a torch etc. Alternatively, an audio or an acoustic sensor could be used, which is configured to respond to a suitable form of audible signal, e.g. ‘clicking’ of fingers or even verbal commands. The acoustic sensor could also be configured to operate at ultra-sonic frequencies.

In infra-red sensor arrangements, the controller is preferably adapted so as to be programmable, in that the user may select any existing infra-red remote control hand unit (e.g. a television remote control etc.) so as to program the controller to respond to one of the unit's prescribed signals. For instance, a user may select the ON/OFF button of the hand unit to be the control button for switching of the socket bank 1. The controller can then be programmed to isolate or connect the master electrical outlet 2 to the power supply, whenever the prescribed signal corresponding to the ON/OFF button is received by the remote control switching unit.

In preferred arrangements, the controller is programmed by depressing the override switch for a predetermined minimum time, e.g. about 10 seconds, and then holding the depressed switch, which causes the controller to enter a ‘programming’ mode. The selected button (e.g. ON/OFF) on the hand unit is then pressed, while the unit is pointed towards the sensor, so that the controller can determine timing information from the prescribed signal. The override switch is then released, which causes the controller to connect the master electrical outlet 2 to the power supply. To complete the programming, the user presses the selected button on the hand unit again, which prompts the controller to store the timing information and acknowledge completion of the programming mode by isolating the master electrical outlet 2 from the power supply.

It is to be appreciated that any suitable technique of programming the controller to recognise one or more prescribed remote control signals may be used, the foregoing arrangement serving only as a preferred example. Moreover, any suitable means of confirming and/or acknowledging commencement and completion of the programming mode may be used, including visual notification (via e.g. an LED or neon etc.) and/or audio notification (e.g. a beep from a piezo buzzer etc.).

The information corresponding to the prescribed signal(s) is preferably stored in a non-volatile storage means residing within, or coupled to, the controller circuitry. In this way, the programmed information is preserved when the socket bank 1 is disconnected from the power supply, thereby avoiding the need to re-program the controller during subsequent use of the socket bank 1.

After the controller has been programmed, the user may then simply isolate or connect the master electrical outlet 2 to the power supply by pressing the selected button on the remote control hand unit. Preferably, if no master device is connected, or the master device does not turn on within a predetermined period, preferably in the range of about 10 seconds to about 30 seconds, and most preferably about 15 seconds, the controller will then act to isolate the master electrical outlet 2 from the power supply, thereby avoiding the outlet 2 from being ‘live’ when it is not needed.

In preferred arrangements, the socket bank 1 may be configured to communicate with other socket banks via mains signalling techniques, as described previously, such that the remote control hand unit can be used to connect the master electrical outlet 2 of each of the networked socket banks to the mains supply, by simply turning on one of the socket banks by way of the hand unit.

Although the power distribution apparatus of the present invention has been described in relation to a trailing socket bank 1, it is to be appreciated that the physical arrangement of the master and slave electrical outlets can be configured into any suitable 3-dimensional geometrical shape and structure. Therefore, according to the present invention, there are shown in FIGS. 4-6, example arrangements in which the power distribution apparatus has been configured into a substantially ‘cubic’ socket assembly, thereby offering considerable space saving advantages and convenience of use.

It is to be understood that these examples are not limiting, and therefore each serves as an illustration of one possible cubic configuration that may be adopted by the power distribution apparatus of the present invention.

Referring to FIGS. 4(a)-(c), there are shown different views of a particularly preferred arrangement of the power distribution apparatus 200 (hereinafter referred to as the ‘socket cube’). In this arrangement, there is one master electrical outlet 202 and two slave electrical outlets 203, each disposed on a respective orthogonal face of the socket cube 200. The slave electrical outlets 203 are mounted on either side of the socket cube 200, with the master electrical outlet 202 being located on an orthogonal face therebetween.

For ease of use and reference for the user, the master electrical outlet 202 can be coloured coded and/or marked in some way, e.g. by applying a suitable paint or permanent transfer etc. to the corresponding face of the socket cube 200. In this way, the chances of the user inadvertently plugging a master device into a slave electrical outlet 203 can be significantly reduced.

The socket cube 200 includes integral electrical pin connectors 204, to permit insertion into a mains power supply socket. The pins 204 provide power to the master electrical outlet 202 and selectively to the slave electrical outlets 203, in accordance with the operation of the present controller. The master and slave electrical connections (i.e. power rails) are enclosed within the socket cube 200, and a mains rated fuse 205 is included for electrical safety purposes.

For additional safety, the apertures associated with the master and slave electrical outlets 202, 203 may be covered by internal, retractable shutters, which mechanically retract whenever a master or slave device is inserted into a respective outlet. In this way, the chances of inadvertently touching a power rail can be further minimised when inserting or removing devices. Moreover, the shutters provide an additional advantage that dust and other debris is prevented from getting inside of the socket cube 200 when not in use.

Referring again to FIG. 4(a), the area generally designated by 206 contains the internal controller, as described in detail in relation to the previous arrangements. The physical configuration of the controller will be understood to be dependent on the particular size and shape of the socket cube 200. Therefore, the configuration of the controller may differ slightly between different arrangements, depending on the components used.

To provide the user with a visual indication that the socket cube 200 is in use, a LED 207 is mounted on a surface of the cube. This can optionally be turned on whenever the cube receives power or only when a master device is inserted into the master electrical outlet 202. To permit easy viewing, the LED 207 is located on an outwardly facing surface of the cube (e.g. on a face substantially opposite to the pin connectors). Additional LEDs may be included to indicate the power status of the attached slave devices etc.

In accordance with earlier arrangements, the socket cube 200 can also include an infra-red sensor 208 which permits remote control of the cube via a suitable hand held device etc. Alternatively, other sensor types may be used including optical, ultrasonic and wireless (e.g. WiFi, Bluetooth). As shown in FIG. 4(a), the sensor 208 is mounted on the cube face that is opposite to the electrical pin connectors 204 (i.e. outwardly facing), so as to provide the widest angular coverage for detection of transmitted signals.

The socket cube 200 may also include one or more interface ports and/or connectors (e.g. USB, RS232, Firewire), as described in relation to earlier arrangements. In FIG. 4(c), the socket cube is illustrated as including a telephone jack connector 209, e.g. type RJ11. This connector can provide a connection to a telecommunications device, such as, but not limited to, a telephone, modem or fax machine etc. or alternatively, a network adaptor card.

Referring to FIGS. 5 and 6, there are illustrated other arrangements of the socket cube 200, with like features being labelled consistently with FIG. 4. In these arrangements, the socket cube comprises a elongated portion, denoted generally by 206, in which is housed the internal controller. In this way, additional space can be provided for a further outlet socket which may be an additional master 202 or another slave electrical outlet 203, as shown.

Other arrangements are taken to be within the scope of the accompanying claims.

1. A power distribution apparatus comprising:
a master electrical outlet and at least one slave electrical outlet, both connectable to a common power supply;
a sampling means adapted to sample power drawn from the master electrical outlet; and
a controller adapted to calculate an updating average of a plurality of sampled power levels and operable to isolate the slave electrical outlet from the power supply in response to a prescribed change in the calculated average power drawn from the master electrical outlet relative to a switching threshold.

2. The apparatus of claim 1, wherein the switching threshold is automatically calculated.

3. The apparatus of claim 1 or claim 2, wherein the switching threshold is based on the calculated averages of the maximum power and minimum power drawn from the master electrical outlet.

4. The apparatus of claim 3, wherein the sampling means is operable to sample the power drawn at sampling intervals of between about 0.1 and about 1 second.

5. The apparatus of claim 4, wherein the updating average is calculated as a rolling average of the plurality of sampled power levels.

6. The apparatus of claim 5, wherein the prescribed change corresponds to a fall in the calculated average power drawn from the master electrical outlet below the level of the switching threshold.

7. The apparatus of claim 6, wherein the controller includes at least one pre-programmed algorithm to control the switching of the slave electrical outlet.

8. The apparatus of claim 7, wherein the switching is based on conditional logic.

9. The apparatus of claim 8, wherein the algorithm is adapted to calculate the updating average and the averages of the maximum power and minimum power drawn from the master electrical outlet.

10. The apparatus of claim 9, wherein the algorithm calculates the switching threshold using the relationship Pₛₜ=Pₘᵢₙ+f[Pₘₐₓ−Pₘᵢₙ], where Pₛₜ is the switching threshold, Pₘᵢₙ is the calculated average minimum power, Pₘₐₓ is the calculated average maximum power and f is a predetermined fraction.

11. The apparatus of claim 10, wherein the predetermined fraction f is in the range of about 0.15 to about 0.40.

12. The apparatus of claim 11, wherein the sampling means is further adapted to monitor changes in an electrical signal derived from a master device which is drawing power from the master electrical outlet, the changes in the signal corresponding to changes in the operating state of the master device.

13. The apparatus of claim 12, wherein the controller is further operable to isolate the slave electrical outlet from the power supply in response to a prescribed change in the electrical signal.

14. The apparatus of claim 13, wherein the prescribed change in the electrical signal corresponds to a change in operating state of the master device from a first, higher power level to a second, lower power level.

15. The apparatus of claim 14, wherein the electrical signal is an output voltage taken from one or more of the serial port, parallel port, Firewire port, ISA bus, PCI bus and universal serial bus (JSB).

16. The apparatus of claim 14, wherein the electrical signal is an electromagnetic wave corresponding to one of the wireless protocols, WiFi and Bluetooth.

17. The apparatus of claim 16, wherein the plurality of sampled power levels is greater than or equal to 2.

18. The apparatus of claim 17, wherein the controller is operable to initially set the switching threshold to a default nominal value when the apparatus is first connected to a power supply.

19. The apparatus of claim 18, wherein the default nominal value is in the range of about 1 to about 30 W.

20. The apparatus of claim 19, wherein the controller is operable to connect the slave electrical outlet to the power supply, in response to a rise in the calculated average power drawn from the master electrical outlet above the switching threshold.

21. The apparatus of claim 20, wherein the controller comprises an electrical switching means operable to isolate or connect the slave electrical outlet to the power supply, in response to a respective fall or rise in the calculated average power drawn relative to the switching threshold.

22. The apparatus of claim 21, further comprising an interface for connecting to a personal computer.

23. The apparatus of claim 22, wherein the interface comprises a standard USB interface for connection to a USB port on the personal computer.

24. The apparatus of claim 23, wherein the interface includes a plurality of standard USB interface ports each suitable for connection to a USB peripheral device.

25. The apparatus of claim 24, wherein the interface is a multiple port USB hub.

26. The apparatus of claim 25, wherein the controller is adapted to provide a data stream comprising one or more power consumption statistics.

27. The apparatus of claim 26, further comprising an event logger operable to receive the data stream and to interpret the statistics for providing analysis and/or a graphical output.

28. The apparatus of claim 27, wherein the data stream is provided via a standard USB interface for connection to a USB port on a personal computer.

29. The apparatus of claim 28, wherein the event logger is adapted to receive the power consumption statistics in real-time or periodically as a batch of historical data.

30. The apparatus of claim 29, further comprising an interface for connecting to a standard household telephone line.

31. The apparatus of claim 30, wherein the interface comprises a standard telephone connector suitable for connection to a standard household telephone socket.

32. The apparatus of claim 31, wherein the interface includes a plurality of standard household telephone sockets each suitable for connection to a telecommunications device.

33. The apparatus of claim 32, wherein the interface is a multi-way telephone socket adaptor.

34. A method of power distribution comprising the steps of:
supplying electrical power to a master electrical outlet and at least one slave electrical outlet via a common power supply;
sampling power drawn from the master electrical outlet via a sampling means;
calculating, by way of a controller, an updating average of a plurality of sampled power levels; and isolating the slave electrical outlet from the power supply in response to a prescribed change in the calculated average power drawn from the master electrical outlet relative to a switching threshold.
